(19) United States
(12) Patent Application Publication
(10) Pub. No.: US 2026/0155445 A1
(43) Pub. Date: Jun. 4, 2026

(54) AN ELECTROCHEMICAL CELL ELECTROLYTE, AND CELLS THEREOF

(71) Applicant: SUPERIONICS INC., Calgary (CA)

(72) Inventors: Chengtian ZHOU, Calgary (CA); Venkataraman THANGADURAI, Calgary (CA)

(21) Appl. No.: 18/994,508

(22) PCT Filed: Jul. 13, 2023
(86) PCT No.: PCT/CA2023/050940

§ 371 Date: Jan. 14, 2025

Related U.S. Application Data
(60) Provisional application No. 63/389,407, filed on Jul. 15, 2022.

(51) Int. Cl. H01M 10/0569; H01M 10/0525; H01M 10/0567; H01M 10/0568; H01M 10/42

(52) U.S. Cl. CPC H01M 10/0569; H01M 10/0525; H01M 10/0567; H01M 10/0568; H01M 10/4235; H01M 2220/10; H01M 2300/0034; H01M 2300/004

(57) ABSTRACT

An electrochemical cell electrolyte is described, where the electrolyte includes a solvating solvent comprising a linear ester, a cyclic ester, or a combination thereof; a non-solvating solvent; and an alkali metal salt.

### CROSS REFERENCE TO RELATED APPLICATION

This application claims priority to U.S. Provisional Patent Application No. 63/389,407, filed Jul. 15, 2022, the entire contents of which are hereby incorporated by reference.

### FIELD

The present disclosure relates generally to electrochemical cell electrolytes, and electrochemical cells.

### BACKGROUND

Lithium-ion batteries (LiBs) have largely dominated the market for electric vehicles and portable electronics due to their excellent cycle life and improved energy density compared with other known secondary batteries.¹⁻³ However, LiB fire and explosion accidents occur worldwide due to highly flammable electrolytes inside. Localized high concentration electrolytes (LHCE) have been developed by diluting a highly concentrated electrolyte solution (HCE) with non-solvating hydrofluoroethers (HFEs). Electron density of oxygen atoms in a HFE tends to be pulled away by the substituted fluorine atoms, and so the HFE has negligible Li-ion solvating capability. However, HFEs are miscible with a typical solvating solvent, such as dimethoxyethane (DME) or dimethyl carbonate (DMC), and the resulting mixture tends to be homogeneous and Li-ion conducting. Similar to an HCE, LHCE have found success in Li-metal batteries, as it forms an inorganic-rich solid electrolyte interphase (SEI) on the Li metal anode that can slow down parasitic reactions.⁴ LHCE has some advantages over HCE in terms of lower viscosity and lower cost. Further, as highly fluorinated HFEs are nonflammable, LHCEs can offer better safety than normal liquid electrolytes. LHCE has also been explored in LiBs with graphite or silicon anodes.⁵

### SUMMARY

In an aspect of the present disclosure, there is provided an electrochemical cell electrolyte comprising: a solvating solvent comprising a linear ester, a cyclic ester, or a combination thereof; a non-solvating solvent; and an alkali metal salt.

In an embodiment of the present disclosure, there is provided an electrolyte wherein the alkali metal salt is present at a concentration between about 1M to about 4M, between about 1M to about 3M; or between about 1M to about 2M in the solvating solvent.

In another embodiment, there is provided an electrolyte wherein the alkali metal salt is present at a concentration between about 0.2M to about 3.3M, or between about 0.5M to about 2M; or between about 0.5M to about 1M in the combination of solvating solvent and non-solvating solvent.

In another embodiment, there is provided an electrolyte wherein the solvating solvent has a freezing point below 0° C., a viscosity of ≤0.5 cP, and/or a dielectric constant ≥5. In another embodiment, there is provided an electrolyte wherein the solvating solvent comprises a solvent that coordinates with metal ions in a metal ion solution having a metal ion concentration of ≥0.5M.

In another embodiment, there is provided an electrolyte wherein the solvating solvent comprises a linear alkyl ester, a cyclic alkyl ester, or a combination thereof.

In another embodiment, there is provided an electrolyte wherein the solvating solvent further comprises a linear carbonate ester, a cyclic carbonate ester, or a combination thereof.

In another embodiment, there is provided an electrolyte wherein the solvating solvent comprises an alkyl ethanoate, a fluoro-alkyl ethanoate, an alkyl propionate, a fluoro-alkyl propionate, or a combination thereof.

In another embodiment, there is provided an electrolyte wherein the solvating solvent comprises a dialkyl carbonate, a fluoro-dialkyl carbonate, an alkylene carbonate, a fluoro-alkylene carbonate, or a combination thereof.

In another embodiment, there is provided an electrolyte wherein the solvating solvent comprises methyl acetate, ethyl acetate, methyl propionate, ethyl propionate, or a combination thereof.

In another embodiment, there is provided an electrolyte wherein the solvating solvent comprises ethylene carbonate, fluoroethylene carbonate, vinylene carbonate, or a combination thereof.

In another embodiment, there is provided an electrolyte wherein the solvating solvent comprises dimethyl carbonate, diethyl carbonate, propylene carbonate, or a combination thereof.

In another embodiment, there is provided an electrolyte wherein the non-solvating solvent comprises a linear fluoro-alkyl ether.

In another embodiment, there is provided an electrolyte wherein the non-solvating solvent comprises benzotrifluoride, methoxyperfluorobutane, bis(2,2,2-trifluoroethyl)ether, 2,2,2-trifluoroethyl acetate, 1H, 1H,5H-octafluoropentyl 1,1,2,2-tetrafluoroethyl ether, 1,1,1,3,3,3-hexafluoroisopropyl methyl ether, 1,1,2,2-tetrafluoroethyl-2,2,2-trifluoroethyl ether, 1,1,2,2-tetrafluoroethyl-2,2,3,3-tetrafluoropropyl ether, or a combination thereof.

In another embodiment, there is provided an electrolyte wherein the solvating solvent makes up about 20% to about 80% of the total volume.

In another embodiment, there is provided an electrolyte wherein the linear ester, cyclic ester, or combination thereof make up about 20% to about 99% of the solvating solvent, and/or the linear carbonate ester, cyclic carbonate ester, or combination thereof make up about 1% to about 80% of the solvating solvent.

In another embodiment, there is provided an electrolyte wherein the non-solvating solvent makes up about 10% to about 80% of the total volume.

In another embodiment, there is provided an electrolyte wherein the alkali metal salt comprises a monovalent salt. In another embodiment, the alkali metal salt is not a multivalent salt.

In another embodiment, there is provided an electrolyte wherein the alkali metal salt comprises a lithium salt, sodium salt, potassium salt, rubidium salt, or cesium salt. In another embodiment, the alkali metal salt comprises a lithium salt, sodium salt, or potassium salt. In another embodiment, the alkali metal salt comprises a lithium salt, or sodium salt. In another embodiment, the alkali metal salt comprises a lithium salt.

In another embodiment, there is provided an electrolyte wherein the alkali metal salt comprises a lithium cation and a fluoro-substituted anion. In another embodiment, the alkali metal salt comprises lithium hexafluorophosphate (LiPF₆), lithium bis(fluorosulfonyl)imide (LiFSI), lithium difluorophosphate (LFO), lithium bis(oxalato)borate (LiBOB), lithium difluoro(oxalato)borate (LIDFOB), lithium bis(trifluoromethylsulphonyl)imide (LiTFSI), lithium tetrafluoroborate(LiBF₄), or a combination thereof.

In another embodiment, there is provided an electrolyte further comprising an electrolyte additive.

In another embodiment, there is provided an electrolyte wherein the electrolyte additive comprises an alkylene carbonate; carbon dioxide, ethylene sulfite, ethylene sulfate, propylene sulfite, 1,3-propane sultone, 1,3-propene sultone, perfluoro(2-methyl-3-pentanone); or a combination thereof.

In another aspect of the present disclosure, there is provided a half galvanic cell comprising a reference electrode, a working electrode, and the electrolyte as described herein.

In another aspect of the present disclosure, there is provided a full galvanic cell comprising an anode, a cathode, and the electrolyte as described herein.

In another embodiment, there is provided a galvanic cell where the reference electrode comprises Li; the working electrode comprises graphite, silicon, a graphite/silicon mixture, LiNi_{0.6}Mn_{0.2}C_{00.2}O₂ (NMC₆₂₂), LiNi_{0.5}Mn_{0.3}C_{00.2}O₂ (NMC₅₃₂), LiCoO₂, LiFePO₄, NCA, NMC811, an Li metal oxide, an Li metal oxide comprising Ni, Mn, Co, and/or Al, or a combination thereof; the anode comprises graphite, silicon, a graphite/silicon mixture, or a combination thereof; the cathode comprises LiNi_{0.6}Mn_{0.2}C_{00.2}O₂ (NMC₆₂₂), LiNi_{0.5}Mn_{0.3}C_{00.2}O₂ (NMC₅₃₂), LiCoO₂, LiFePO₄, NCA, NMC811, an Li metal oxide, an Li metal oxide comprising Ni, Mn, Co, and/or Al, or a combination thereof; or a combination thereof.

In another aspect of the present disclosure, there is provided a battery comprising the electrolyte as described herein.

In another embodiment of the present disclosure, there is provided a battery wherein the battery is operable at a temperature of about −30° C. or higher.

In another aspect of the present disclosure, there is provided an electrochemical cell comprising: an anode; a cathode; and an electrolyte, the electrolyte comprising: a solvating solvent comprising a linear ester, a cyclic ester, or a combination thereof; a non-solvating solvent; and an alkali metal salt.

In another embodiment of the present disclosure, there is provided a cell wherein the alkali metal salt is present at a concentration between about 1M to about 4M, or between about 1M to about 3M; or between about 1M to about 2M in the solvating solvent.

In another embodiment, there is provided a cell wherein the alkali metal salt is present at a concentration between about 0.2M to about 3.3M, or between about 0.5M to about 2M; or between about 0.5M to about 1M in the combination of solvating solvent and non-solvating solvent.

In another embodiment, there is provided a cell wherein the solvating solvent has a freezing point below 0° C., a viscosity of ≤0.5 cP, and/or a dielectric constant ≥5. In another embodiment, there is provided a cell wherein the solvating solvent comprises a solvent that coordinates with metal ions in a metal ion solution having a metal ion concentration of ≥0.5M.

In another embodiment, there is provided a cell wherein the solvating solvent comprises a linear alkyl ester, a cyclic alkyl ester, or a combination thereof.

In another embodiment, there is provided a cell wherein the solvating solvent further comprises a linear carbonate ester, a cyclic carbonate ester, or a combination thereof.

In another embodiment, there is provided a cell wherein the solvating solvent comprises an alkyl ethanoate, a fluoro-alkyl ethanoate, an alkyl propionate, a fluoro-alkyl propionate, or a combination thereof.

In another embodiment, there is provided a cell wherein the solvating solvent comprises a dialkyl carbonate, a fluoro-dialkyl carbonate, an alkylene carbonate, a fluoro-alkylene carbonate, or a combination thereof.

In another embodiment, there is provided a cell wherein the solvating solvent comprises methyl acetate, ethyl acetate, methyl propionate, ethyl propionate, or a combination thereof.

In another embodiment, there is provided a cell wherein the solvating solvent comprises ethylene carbonate, fluoroethylene carbonate, vinylene carbonate, or a combination thereof.

In another embodiment, there is provided a cell wherein the solvating solvent comprises dimethyl carbonate, diethyl carbonate, propylene carbonate, or a combination thereof.

In another embodiment, there is provided a cell wherein the non-solvating solvent comprises a linear fluoro-alkyl ether.

In another embodiment, there is provided a cell wherein the non-solvating solvent comprises benzotrifluoride, methoxyperfluorobutane, bis(2,2,2-trifluoroethyl)ether, 2,2,2-trifluoroethyl acetate, 1H, 1H,5H-octafluoropentyl 1,1,2,2-tetrafluoroethyl ether, 1,1,1,3,3,3-hexafluoroisopropyl methyl ether, 1,1,2,2-tetrafluoroethyl-2,2,2-trifluoroethyl ether, 1,1,2,2-tetrafluoroethyl-2,2,3,3-tetrafluoropropyl ether, or a combination thereof.

In another embodiment, there is provided a cell wherein the solvating solvent makes up about 20% to about 80% of the total volume.

In another embodiment, there is provided a cell wherein the linear ester, cyclic ester, or combination thereof make up about 20% to about 99% of the solvating solvent, and/or the linear carbonate ester, cyclic carbonate ester, or combination thereof make up about 1% to about 80% of the solvating solvent.

In another embodiment, there is provided a cell wherein the non-solvating solvent makes up about 10% to about 80% of the total volume.

In another embodiment, there is provided a cell wherein the alkali metal salt comprises a monovalent salt. In another embodiment, the alkali metal salt is not a multivalent salt.

In another embodiment, there is provided a cell wherein the alkali metal salt comprises a lithium salt, sodium salt, potassium salt, rubidium salt, or cesium salt. In another embodiment, the alkali metal salt comprises a lithium salt, sodium salt, or potassium salt. In another embodiment, the alkali metal salt comprises a lithium salt, or sodium salt. In another embodiment, the alkali metal salt comprises a lithium salt.

In another embodiment, there is provided a cell wherein the alkali metal salt comprises a lithium cation and a fluoro-substituted anion.

In another embodiment, there is provided a cell wherein the alkali metal salt comprises lithium hexafluorophosphate (LiPF₆), lithium bis(fluorosulfonyl)imide (LiFSI), lithium difluorophosphate (LFO), lithium bis(oxalato)borate (LiBOB), lithium difluoro(oxalato)borate (LiDFOB), lithium bis(trifluoromethylsulphonyl)imide (LiTFSI), lithium tetrafluoroborate(LiBF₄), or a combination thereof.

In another embodiment, there is provided a cell wherein the electrolyte further comprises an electrolyte additive.

In another embodiment, there is provided a cell wherein the electrolyte additive comprises an alkylene carbonate; carbon dioxide, ethylene sulfite, ethylene sulfate, propylene sulfite, 1,3-propane sultone, 1,3-propene sultone, perfluoro(2-methyl-3-pentanone); or a combination thereof.

In another embodiment, there is provided a cell wherein the anode comprises graphite, silicon, a graphite/silicon mixture, or a combination thereof; the cathode comprises LiNi_{0.6}Mn_{0.2}C_{00.2}O₂ (NMC₆₂₂), LiNi_{0.5}Mn_{0.3}C_{00.2}O₂ (NMC₅₃₂), LiCoO₂, LiFePO₄, NCA, NMC811, an Li metal oxide, an Li metal oxide comprising Ni, Mn, Co, and/or Al, or a combination thereof; or a combination thereof.

In another embodiment, there is provided a cell wherein the cell is a galvanic cell.

In another embodiment, there is provided a cell wherein the cell is a battery.

In another embodiment, there is provided a cell wherein the cell is useful for smart windows.

In another embodiment, there is provided a cell wherein the cell is useful for sensors.

In another embodiment, there is provided a cell wherein the cell is operable at a temperature of about −30° C. or higher.

### BRIEF DESCRIPTION OF THE FIGURES

Embodiments of the present disclosure will now be described, by way of example only, with reference to the attached Figures.

FIG. 1 depicts voltage profile of (a) graphite∥NMC622 full cells and (b) Li∥Graphite half cells (dashed line is 1M MP:TTE=1:1; solid line is 1M MP:TTE=1:1 +4 wt % EC). (c) lonic conductivity of different electrolytes, “Add EC” bars represent 1M LiPF₆ in EC:MP:TTE with varying EC ratio; “Reduce TTE” bars represent 1M LiPF₆ in EC:MP:TTE with varying TTE ratio; “Reduce LiPF₆” bars represent different LiPF₆ concentrations in EC:MP:TTE=1:3:4; “Replace with MP” bars represent normal electrolytes.

FIG. 2 depicts coulombic efficiency (CE) of (a) Li∥Graphite and (b) Li∥NMC622 half cells.

FIG. 3 depicts (a-f) ignition experiment of 1M LiPF₆ in EC/DEC, 1M LiPF₆ in EC:MP=1:3 (NE), and 1M LiPF₆ in EC:MP:TTE=1:3:4 (LE), and their self-extinguishing time. (g-i) Wettability tests of 1M LiPF₆ in EC/DEC, 1M LiPF₆ in EC:MP=1:3 (NE), and 1M LiPF₆ in EC:MP:TTE=1:3:4 (LE) on a polypropylene (PP) separator. Images were taken at 3s after 8 μl of electrolyte dropped on the separator.

FIG. 4 depicts (a) and (b) 13C NMR spectra of 1M LiPF₆ in EC:MP:TTE=1:3:4 (1M LE; solid line), 1M LiPF₆ in EC:MP=1:3 (1M NE; dash-dot line), and 2M LiPF₆ in EC:MP=1:3 (2M NE; dashed line). (c) and (d) FTIR spectrum of 1M LE, 1M NE, and 2M NE. (e) and (f) Raman spectrum of 1M LE, 1M NE, and 2M NE.

FIG. 5A (a-c) depicts solvation structure model of different electrolytes. The bulk electrolyte can be considered as repeating units, and the model represents a single unit. The stoichiometric number is calculated by salt concentration and solvents'volume, the solvation number is calculated from Raman spectroscopy. A smaller sized oval represents a fraction of a molecule).

FIG. 5B (a-c) depicts solvation structure model of different electrolytes. The bulk electrolyte can be considered as repeating units, and the model represents a single unit. The stoichiometric number is calculated by salt concentration and solvents'volume, the solvation number is calculated from Raman spectroscopy. A smaller sized oval represents a fraction of a molecule.

FIG. 6 depicts (a) Capacity retention profile of different electrolytes (0.5M NE (triangle), 1.4M NE (hexagon), 0.5M LE (upside-down triangle), 0.7M LE (diamond), 1.0M LE (circle)), (b) Rate performance of cells with excess electrolyte (1M LE (circle), 1M NE (upside-down triangle), 1M EC/DEC (triangle)), (c) Rate performance of cells with lean electrolyte (1M LE (circle), 1M NE (upside-down triangle), 1M EC/DEC (triangle)).

FIG. 7 depicts SEM images of cycled graphite∥NCM622 cells. (a) NMC622 cathode with 1.4M NE, after 149 cycles. (b) NMC622 cathode with 1M LE, after 200 cycles. (c) Graphite anode with 1.4M NE, after 149 cycles. (d) Graphite anode with 1M LE, after 200 cycles. (e-g) EDX mapping of (c).

FIG. 8 depicts cycling performance of graphite∥NCM622 cells employing LE with different MP:EC:TTE ratio and different LiPF₆ concentrations.

FIG. 9 depicts cycling performance of graphite∥NCM 622 cells with 0.7M LE +2 wt % VC and 0.7M NE+2 wt % VC. The top graph is the CE of the cell with 0.7M LE+2 wt % VC. The bottom graph shows Capacity vs. Cycles, with the top line representing non-flammable electrolyte and the bottom line representing conventional electrolyte.

FIG. 10 depicts cycling performance (0.5C) of graphite∥NCA cells employing 1M LiPF₆ in MA:FEC:HFE-458 =5:1:6, where MA is methyl acetate, FEC is fluoroethylene carbonate, and HFE-458 is 1,1,2,2-tetrafluoroethyl-2, 2, 3, 3-tetrafluoropropyl ether.

FIG. 11 depicts a discharge voltage profile of a graphite∥NCA cell employing 1M LiPF₆ in MA:FEC:HFE-458=5:1:6, where MA is methyl acetate, FEC is fluoroethylene carbonate, and HFE-458 is 1,1,2,2-tetrafluoroethyl-2,2,3,3-tetrafluoropropyl ether at −30° C., in comparison to the graphite∥NCA cell with 1M LiPF₆ in EC:DMC=1:1.

FIG. 12 depicts capacity retention of a pouch cell using a graphite anode and LiNi_{0.5}Mn_{0.3}C _{00.2}O₂ (NMC₅₃₂) cathode with electrolyte 1M LiPF₆ in MA:FEC:HFE-458=5:1:6in comparison to the pouch cell with 1M LiPF₆ in EC:DMC=1:1 as electrolyte.

### DETAILED DESCRIPTION

Definitions Unless defined otherwise, all technical and scientific terms used herein have the meaning as commonly understood in the art.

As used in the specification and claims, the singular forms “a”, “an” and “the” include plural references unless the context dictates otherwise.

Used herein, the term “solvating solvent” refers to a polar compound.

Used herein, the term “non-solvating solvent” refers to a nonpolar compound.

Generally, the present disclosure provides an electrochemical cell electrolyte comprising: a solvating solvent comprising a linear ester, a cyclic ester, or a combination thereof; a non-solvating solvent; and an alkali metal salt.

In an example of the present disclosure, there is provided an electrolyte wherein the alkali metal salt is present at a concentration between about 1M to about 4M, or between about 1M to about 3M; or between about 1M to about 2M in the solvating solvent.

In another example, there is provided an electrolyte wherein the alkali metal salt is present at a concentration between about 0.2M to about 3.3M, or between about 0.5M to about 2M; or between about 0.5M to about 1M in the combination of solvating solvent and non-solvating solvent.

In another example, there is provided an electrolyte wherein the solvating solvent has a freezing point below 0° C., a viscosity of ≤0.5 cP, and/or a dielectric constant ≥5. In another example, there is provided an electrolyte wherein the solvating solvent comprises a solvent that coordinates with metal ions in a metal ion solution having a metal ion concentration of ≥0.5M.

In another example, there is provided an electrolyte wherein the solvating solvent comprises a linear alkyl ester, a cyclic alkyl ester, or a combination thereof.

In another example, there is provided an electrolyte wherein the solvating solvent further comprises a linear carbonate ester, a cyclic carbonate ester, or a combination thereof.

In another example, there is provided an electrolyte wherein the solvating solvent comprises an alkyl ethanoate, a fluoro-alkyl ethanoate, an alkyl propionate, a fluoro-alkyl propionate, or a combination thereof.

In another example, there is provided an electrolyte wherein the solvating solvent comprises a dialkyl carbonate, a fluoro-dialkyl carbonate, an alkylene carbonate, a fluoro-alkylene carbonate, or a combination thereof.

In another example, there is provided an electrolyte wherein the solvating solvent comprises methyl acetate, ethyl acetate, methyl propionate, ethyl propionate, or a combination thereof.

In another example, there is provided an electrolyte wherein the solvating solvent comprises ethylene carbonate, fluoroethylene carbonate, vinylene carbonate, or a combination thereof.

In another example, there is provided an electrolyte wherein the solvating solvent comprises dimethyl carbonate, diethyl carbonate, propylene carbonate, or a combination thereof.

In another example, there is provided an electrolyte wherein the non-solvating solvent comprises a linear fluoro-alkyl ether.

In another example, there is provided an electrolyte wherein the non-solvating solvent comprises benzotrifluoride, methoxyperfluorobutane, bis(2,2,2-trifluoroethyl)ether, 2,2,2-trifluoroethyl acetate, 1H, 1H,5H-octafluoropentyl 1,1,2,2-tetrafluoroethyl ether, 1,1,1,3,3,3-hexafluoroisopropyl methyl ether, 1,1,2,2-tetrafluoroethyl-2,2,2-trifluoroethyl ether, 1,1,2,2-tetrafluoroethyl-2,2,3,3-tetrafluoropropyl ether, or a combination thereof.

In another example, there is provided an electrolyte wherein the solvating solvent makes up about 20% to about 80% of the total volume.

In another example, there is provided an electrolyte wherein the linear ester, cyclic ester, or combination thereof make up about 20% to about 99% of the solvating solvent, and/or the linear carbonate ester, cyclic carbonate ester, or combination thereof make up about 1% to about 80% of the solvating solvent.

In another example, there is provided an electrolyte wherein the non-solvating solvent makes up about 10% to about 80% of the total volume.

In another example, there is provided an electrolyte wherein the alkali metal salt comprises a monovalent salt. In another example, the alkali metal salt is not a multivalent salt.

In another example, there is provided an electrolyte wherein the alkali metal salt comprises a lithium salt, sodium salt, potassium salt, rubidium salt, or cesium salt. In another example, the alkali metal salt comprises a lithium salt, sodium salt, or potassium salt. In another example, the alkali metal salt comprises a lithium salt, or sodium salt. In another example, the alkali metal salt comprises a lithium salt.

In another example, there is provided an electrolyte wherein the alkali metal salt comprises a lithium cation and a fluoro-substituted anion. In another example, the alkali metal salt comprises lithium hexafluorophosphate (LiPF₆), lithium bis(fluorosulfonyl)imide (LIFSI), lithium difluorophosphate (LFO), lithium bis(oxalato)borate (LiBOB), lithium difluoro(oxalato)borate (LiDFOB), lithium bis(trifluoromethylsulphonyl)imide (LiTFSI), lithium tetrafluoroborate(LiBF₄), or a combination thereof.

In another example, there is provided an electrolyte further comprising an electrolyte additive.

In another example, there is provided an electrolyte wherein the electrolyte additive comprises an alkylene carbonate; carbon dioxide, ethylene sulfite, ethylene sulfate, propylene sulfite, 1,3-propane sultone, 1,3-propene sultone, perfluoro(2-methyl-3-pentanone); or a combination thereof.

Generally, the present disclosure also provides a half galvanic cell comprising a reference electrode, a working electrode, and the electrolyte as described herein.

Generally, the present disclosure also provides a full galvanic cell comprising an anode, a cathode, and the electrolyte as described herein.

In another example, there is provided a galvanic cell where the reference electrode comprises Li; the working electrode comprises graphite, silicon, a graphite/silicon mixture, LiNi_{0.6}Mn_{0.2}C_{00.2}O₂ (NMC₆₂₂), LiNi_{0.5}Mn_{0.3}C_{00.2}O₂ (NMC₅₃₂), LiCoO₂, LiFePO₄, NCA, NMC811, an Li metal oxide, an Li metal oxide comprising Ni, Mn, Co, and/or Al, or a combination thereof; the anode comprises graphite, silicon, a graphite/silicon mixture, or a combination thereof; the cathode comprises LiNi_{0.6}Mn_{0.2}C_{00.2}O₂ (NMC₆₂₂), LiNi_{0.5}Mn_{0.3}C_{00.2}O₂ (NMC532), LiCoO₂, LiFePO₄, NCA, NMC811, an Li metal oxide, an Li metal oxide comprising Ni, Mn, Co, and/or Al, or a combination thereof; or a combination thereof.

Generally, the present disclosure also provides a battery comprising the electrolyte as described herein.

In another example of the present disclosure, there is provided a battery wherein the battery is operable at a temperature of about −30° C. or higher.

Generally, the present disclosure also provides an electrochemical cell comprising: an anode; a cathode; and an electrolyte, the electrolyte comprising: a solvating solvent comprising a linear ester, a cyclic ester, or a combination thereof; a non-solvating solvent; and an alkali metal salt.

In another example of the present disclosure, there is provided a cell wherein the alkali metal salt is present at a concentration between about 1M to about 4M, or between about 1M to about 3M; or between about 1M to about 2M in the solvating solvent.

In another example, there is provided a cell wherein the alkali metal salt is present at a concentration between about 0.2M to about 3.3M, or between about 0.5M to about 2M; or between about 0.5M to about 1M in the combination of solvating solvent and non-solvating solvent.

In another example, there is provided a cell wherein the solvating solvent has a freezing point below 0° C., a viscosity of ≤0.5 cP, and/or a dielectric constant ≥5. In another example, there is provided a cell wherein the solvating solvent comprises a solvent that coordinates with metal ions in a metal ion solution having a metal ion concentration of ≥0.5M.

In another example, there is provided a cell wherein the solvating solvent comprises a linear alkyl ester, a cyclic alkyl ester, or a combination thereof.

In another example, there is provided a cell wherein the solvating solvent further comprises a linear carbonate ester, a cyclic carbonate ester, or a combination thereof.

In another example, there is provided a cell wherein the solvating solvent comprises an alkyl ethanoate, a fluoro-alkyl ethanoate, an alkyl propionate, a fluoro-alkyl propionate, or a combination thereof.

In another example, there is provided a cell wherein the solvating solvent comprises a dialkyl carbonate, a fluoro-dialkyl carbonate, an alkylene carbonate, a fluoro-alkylene carbonate, or a combination thereof.

In another example, there is provided a cell wherein the solvating solvent comprises methyl acetate, ethyl acetate, methyl propionate, ethyl propionate, or a combination thereof.

In another example, there is provided a cell wherein the solvating solvent comprises ethylene carbonate, fluoroethylene carbonate, vinylene carbonate, or a combination thereof.

In another example, there is provided a cell wherein the solvating solvent comprises dimethyl carbonate, diethyl carbonate, propylene carbonate, or a combination thereof.

In another example, there is provided a cell wherein the non-solvating solvent comprises a linear fluoro-alkyl ether.

In another example, there is provided a cell wherein the non-solvating solvent comprises benzotrifluoride, methoxyperfluorobutane, bis(2,2,2-trifluoroethyl)ether, 2,2,2-trifluoroethyl acetate, 1H, 1H,5H-octafluoropentyl 1,1,2,2-tetrafluoroethyl ether, 1,1,1,3,3,3-hexafluoroisopropyl methyl ether, 1,1,2,2-tetrafluoroethyl-2,2,2-trifluoroethyl ether, 1,1,2,2-tetrafluoroethyl-2,2,3,3-tetrafluoropropyl ether, or a combination thereof.

In another example, there is provided a cell wherein the solvating solvent makes up about 20% to about 80% of the total volume.

In another example, there is provided a cell wherein the linear ester, cyclic ester, or combination thereof make up about 20% to about 99% of the solvating solvent, and/or the linear carbonate ester, cyclic carbonate ester, or combination thereof make up about 1% to about 80% of the solvating solvent.

In another example, there is provided a cell wherein the non-solvating solvent makes up about 10% to about 80% of the total volume.

In another example, there is provided a cell wherein the alkali metal salt comprises a monovalent salt. In another example, the alkali metal salt is not a multivalent salt.

In another example, there is provided a cell wherein the alkali metal salt comprises a lithium salt, sodium salt, potassium salt, rubidium salt, or cesium salt. In another example, the alkali metal salt comprises a lithium salt, sodium salt, or potassium salt. In another example, the alkali metal salt comprises a lithium salt, or sodium salt. In another example, the alkali metal salt comprises a lithium salt.

In another example, there is provided a cell wherein the alkali metal salt comprises a lithium cation and a fluoro-substituted anion.

In another example, there is provided a cell wherein the alkali metal salt comprises lithium hexafluorophosphate (LiPF₆), lithium bis(fluorosulfonyl)imide (LiFSI), lithium difluorophosphate (LFO), lithium bis(oxalato)borate (LiBOB), lithium difluoro(oxalato)borate (LiDFOB), lithium bis(trifluoromethylsulphonyl)imide (LiTFSI), lithium tetrafluoroborate(LiBF₄), or a combination thereof.

In another example, there is provided a cell wherein the electrolyte further comprises an electrolyte additive.

In another example, there is provided a cell wherein the electrolyte additive comprises an alkylene carbonate; carbon dioxide, ethylene sulfite, ethylene sulfate, propylene sulfite, 1,3-propane sultone, 1,3-propene sultone, perfluoro(2-methyl-3-pentanone); or a combination thereof.

In another example, there is provided a cell wherein the anode comprises graphite, silicon, a graphite/silicon mixture, or a combination thereof; the cathode comprises LiNi_{0.6}Mn_{0.2}C_{00.2}O₂ (NMC₆₂₂), LiNi_{0.5}Mn_{0.3}C_{00.2}O₂ (NMC₅₃₂), LiCoO₂, LiFePO₄, NCA, NMC811, an Li metal oxide, an Li metal oxide comprising Ni, Mn, Co, and/or Al, or a combination thereof; or a combination thereof.

In another example, there is provided a cell wherein the cell is a galvanic cell.

In another example, there is provided a cell wherein the cell is a battery.

In another example, there is provided a cell wherein the cell is useful for smart windows.

In another example, there is provided a cell wherein the cell is useful for sensors.

In another example, there is provided a cell wherein the cell is operable at a temperature of about −30° C. or higher.

Localized high concentration electrolytes (LHCE) have been used as electrolyte candidates for Li-metal batteries. LHCE may be formed by diluting a high concentration electrolyte (e.g., usually close to saturation) with a low donor number solvent. The practical application of LHCE tends to be hindered. Firstly, the ionic conductivity of a typical LHCE tends to be lower than a traditional carbonate or ether-based electrolyte, making LHCE not suitable for high-rate applications.⁶ For example, localized high concentration electrolytes (LHCEs) generally possess 5−10 times lower ionic conductivity than a typical carbonate-based electrolyte for LiBs.^{6,8} Secondly, many LHCEs use expensive lithium salts, such as lithium bis(fluorosulfonyl)imide (LiFSI), rather than LiPF₆, which increases cost relative to traditional electrolytes.⁷

Described herein is an “localized electrolyte (LE)” composition. In at least one example, the LE is prepared by mixing solvating solvents, such as methyl propionate (MP)/ethylene carbonate (EC), with non-solvating solvents, such as 1,1,2,2-Tetrafluoroethyl 2,2,2-trifluoroethyl ether (TTE), and Li salts, such as LiPF₆. In contrast to LHCEs where a Li salt is almost fully saturated or at least at a high concentration (>4 M) with regards to the solvating solvents, one or more examples of the herein described LEs comprises a Li concentration of about 1M to about 4 M with regards to the solvating solvents and about 0.2 M to about 3.3 M total volume (combination of solvating and non-solvating solvents). In at least one example of the LE described herein, the ionic conductivity of the LE may reach about 7.6 mS/cm (e.g., close to about 8 mS/cm of 1M LiPF₆ in ethylene carbonate/diethyl carbonate (EC/DEC)). In at least one example, the herein described LE supported a LiB's long cycling (700 cycles, ˜4 months) with a concentration of 0.7 M, an electrolyte concentration that is lower than the 1.2−1.5 M of the state-of-the-art LiB.²

In one or more examples, the ionic conductivity of the herein described LE is a result of the ionic transport property of the solvating solvent, such as methyl acetate or methyl propionate. In one or more examples, the herein described LE is flame-retardant, compatible with current LiB electrodes, and/or exhibit relatively high wettability towards electrodes/separator. In one or more examples, the herein described LE enables a high-rate cycling of a Li-ion full cell, e.g., with graphite anode and Ni-rich cathode under a lean electrolyte condition. In one or more examples, the herein described LE costs less than a LHCE, as the Li salt can make up about 60% of an electrolyte's cost, and reducing the salt concentration can reduce the overall cost.

Described herein is a “localized electrolyte (LE)” for Li-ion batteries, which may include a graphite anode and Ni-rich cathode. Li salt concentrations of the LE may be about 1M to about 4M regarding the solvating solvents, and may be about 0.2 M to about 3.3 M overall, where overall is the Li salt concentration in a combination of the solvating and non-solvating solvents. A cell comprising a LE as described herein may deliver faster charging capability and higher capacity retention. In at least one embodiment of the LE as described herein, the LE exhibits non-flammability, and demonstrates superb wettability. In at least one example described herein, with addition of about 2 wt % vinylene carbonate into about 0.7M LE, a Li-ion battery (LiB) retained about 80.3% of its initial capacity after 700 cycles.

To gain a better understanding of the invention described herein, the following examples are set forth. It should be understood that these examples are for illustrative purposes only. Therefore, they should not limit the scope of this invention in anyway.

### EXAMPLES

### Example 1—A Flame-Retardant Localized Electrolyte for Safe and Fast-Charging Lithium-Ion Batteries

### Experimental Aspects

Materials. LiNi_{0.6}Mn_{0.2}C_{00.2}O₂ (NMC₆₂₂), LiNi_{0.8}CO_{0.15}Al0.05O₂ (NCA) were purchased from NEI Corporation, USA. The cathode sheet had an active loading of 12.0 mg/cm². 1M LiPF₆ in ethylene carbonate/diethyl carbonate (EC/DEC 1:1 v/v) was purchased from Sigma Aldrich. LiPF₆, ethylene carbonate (EC), methyl propionate (MP), methyl acetate (MA), fluoroethylene carbonate (FEC) vinylene carbonate (VC), and 1,1,2,2-Tetrafluoroethyl 2,2,2-trifluoroethyl ether (TTE), and 1 1 2 2 -tetrafluoroethyl-2 2 3 3-tetrafluoropropyl ether (HFE458) were purchased from Suzhou Fosai New Material Co., Ltd. Lithium chips were purchased from AME Energy, China.

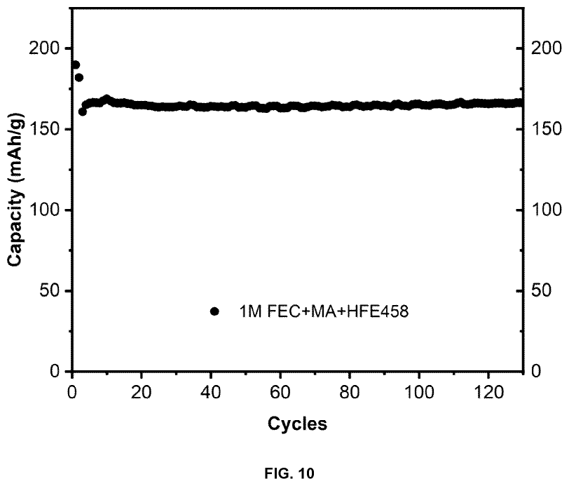

Cell fabrication. Cell fabrication was carried out in an Ar-filled glovebox (Etelux). All cells were assembled in a coin cell (CR2032). A half cell was fabricated using a Li chip as a counter and reference electrode, graphite or NMC622 as the working electrode. The electrolyte was prepared by mixing the components in a vial and stirring with a magnetic stirrer. For example, 1M LE was prepared by mixing 0.152 g LiPF₆ in 1 ml mixture of MP:EC:TTE (3:1:4, v/v). The electrolyte measured as depicted in FIG. 10 was prepared by mixing 0.152 g LiPF₆ in 1 ml mixture of MA:FEC:HFE458 (5:1:6, v/v). A full cell consisted of a graphite anode and an NMC622 cathode. For a cell with lean electrolyte, a polypropylene separator was used, and the electrolyte amount added for each cell was 60 μL. The cell was pressed at a high pressure of 800−1000 Psi with a hydraulic crimping machine. For a cell with excess electrolyte, a glass separator was used to soak more than 300 μL of electrolyte. The cell was pressed at 500−600 Psi.

Characterization. The cyclic test was carried out using a Neware BTS4000 testing station. The electrochemical impedance spectroscopy (EIS) was collected using a potentiostat (VersaSTAT 3, Princeton Applied Research). Scanning electron microscopic (SEM) analysis of the cycled electrodes was conducted with Carl Zeiss supra 40. Energy dispersive X-ray microanalyzer (OXFORD ISI 300 EDAX) was used to analyze the elemental distribution of the electrodes. Fourier Transform Infrared (FTIR) spectral analysis was performed using Thermo-Nicolet Nexus 470 instrument. Raman spectra were recorded on a Witec alpha 300R Confocal Raman Microscope using a 532 nm laser. ¹³C NMR spectra were recorded on a Bruker RDQ400 NMR (Avance III).

### Results and Discussion

Electrolyte compositions. Methyl propionate (MP) was selected as the solvating solvent because of its low freezing point of −87° C., low viscosity (0.43 cP), and medium dielectric constant 6.20.10,11 In comparison, the widely used dimethyl carbonate (DMC) has a freezing point of 4.6° C., viscosity of 0.59 cP, and a dielectric constant of 3.1. A first localized electrolyte (LE) was prepared: 1M LiPF₆ in MP:TTE=1:1 (v/v); where TTE is 1,2,2-Tetrafluoroethyl 2,2,2-trifluoroethyl ether. While TTE was not completely nonflammable, tests found it did reduce overall flammability of the electrolyte. The salt concentration for this LE formula was based on diluting 2M LiPF₆ in methyl propionate (MP). For electrolytes, 2M is not considered a high concentration, and is below the saturation point of LiPF₆ in MP.

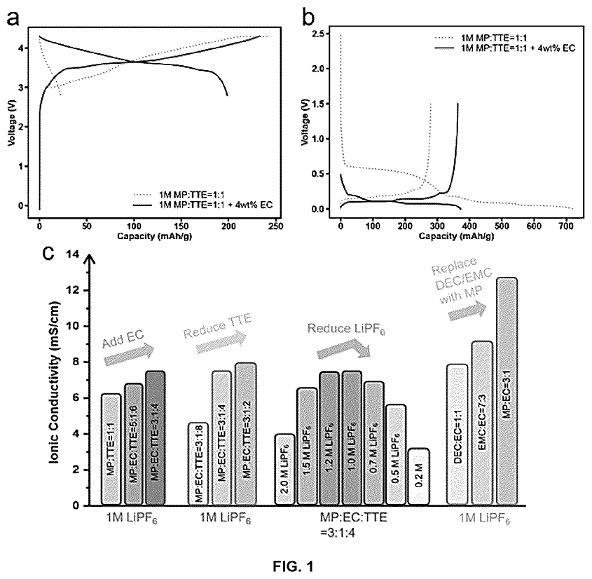

The electrochemical performance of 1M LiPF₆ in MP:TTE=1:1 was tested with a graphite anode and an NMC622 (LiNi_{0.6}Mn_{0.2}C_{00.2}O₂) cathode (FIG. 1a). An unusual charge voltage was observed, and the cell delivered a negligible discharge capacity. In contrast, after introducing 4 wt % of ethylene carbonate (EC), the cell demonstrated a reversible charge-discharge voltage behavior. Such a difference was also reflected in a graphite∥Li half cell (FIG. 1 b). The first lithiation of graphite with 1M LiPF₆ in MP:TTE=1:1 showed a capacity of more than 700 mAh/g, which was more than twice the theoretical capacity. The plateau at ˜0.7 V was attributed to the decomposition of MP. The instability of MP at a low potential was addressed by adding a small amount of EC to form a protective layer at the surface of graphite.

The ionic conductivity of different localized electrolytes (LEs) and normal electrolytes (NEs; without a non-polar diluent) are summarized in FIG. 1c. Increasing the ratio of ethylene carbonate (EC) in the electrolyte was observed to increase the ionic conductivity (see FIG. 1c, first set of bars). The ionic conductivity of 1M LiPF₆ in MP:TTE=1:1, 1M LiPF₆ in EC:MP:TTE=1:5:6, and 1M LiPF₆ in EC:MP:TTE=1:3:4 is 6.3, 6.9, and 7.6 mS/cm, respectively. Generally, an ionic conductivity above 5 mS/cm is considered a relatively high ionic conductivity. For example, LHCEs tend to possess ionic conductivities below 2 mS/cm. Further increasing the EC ratio to EC:MP:TTE=1:2:3 was observed to lead to phase separation of the solution. It was noted that the ionic conductivity of 1M LiPF₆ in EC: DEC=1:1 and 1M LiPF₆ in EC: EMC=3: 7 was measured to be 8.0 and 9.3 mS/cm, where DEC is diethyl carbonate and EMC is ethyl methyl carbonate. The MP-based LE (1M LiPF₆ in EC:MP=1:3; see FIG. 1c, last set of bars) possessed ionic conductivity higher than previously reported LHCE (below 2 mS/cm),⁶ and was closer to commercial Li-ion battery electrolytes. Without wishing to be bound by theory, this may be attributed to the fast ion transport of 1M LiPF₆ in EC:MP=1:3, which exhibited an ionic conductivity of 12.8 mS/cm (FIG. 1c).

After fixing the EC:MP ratio to 1:3, the effect of TTE on the ionic conductivity was studied (see FIG. 1c, second set of bars). When decreasing the amount of TTE from 1M LiPF₆ in EC:MP:TTE=1:3:8 to 1M LiPF₆ in EC:MP:TTE=1:3:4 to 1M LiPF₆ in EC:MP:TTE=1:3:2, its ionic conductivity increased from 4.8 to 8.0 mS/cm. With reference to FIG. 1c, the ionic conductivity of 1M LiPF₆ in EC:MP:TTE=1:3:4 was slightly lower than 1M LiPF₆ in EC:MP:TTE=1:3:2. However, as the LE containing 1M LiPF₆ in EC:MP:TTE=1:3:4 contained more TTE, it also possessed a reduced flammability relative to 1M LiPF₆ in EC:MP:TTE=1:3:2.

Different LiPF₆ concentrations were also studied in EC:MP:TTE=1:3:4, and it was found that when the concentration increases to 2M, the ionic conductivity reduced to 4.1 mS/cm. When the concentration reduced to 0.7M, the ionic conductivity slightly decreased to 7.0 mS/cm (see FIG. 1c, third set of bars).

FIG. 10 graphically depicts the cycling performance of a Li-ion cell with graphite anode and NCA (LiNi_{0.8}Co_{0.15}Al_{0.5}O₂) cathode, where the electrolyte is 1M LiPF₆ in MA/FEC/HFE 458=5:1:6 V/V, where MA is methyl acetate, FEC is fluoroethylene carbonate, and HFE-458 is 1,1,2,2-tetrafluoroethyl-2,2,3,3-tetrafluoropropyl ether. It was observed that the Li-ion cell had negligible capacity fade after cycling for 130 cycles at a cycling rate of 0.5 C.

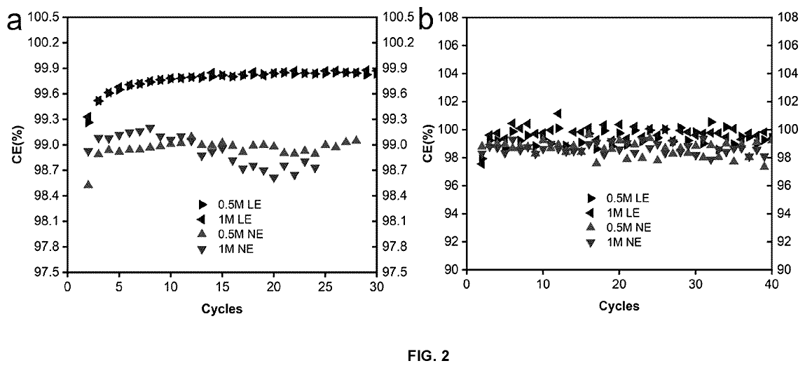

Anode and cathode half cells. Li∥Graphite and Li∥NMC622 (LiNi_{0.6}Mn_{0.2}C_{00.2}O₂) half cells were assembled to assess the compatibility of localized electrolytes (LEs) and normal electrolytes (NEs) with anode and cathode. The solvent ratio was fixed at EC:MP:TTE=1:3:4 for LEs and EC:MP=1:3 for NEs. FIG. 2a shows the Coulombic efficiency (CE) of Li∥Graphite half cells. For both 1M and 0.5M LE, the CE increased with cycling due to a more and more passivating interface, and their CEs stabilized at about 99.9%. In comparison, the anode half cells of 1M and 0.5M NE demonstrated lower CE, indicating more Li lost in each cycle. The CEs of Li∥NMC622 half cells are shown in FIG. 2b. The averaged CEs followed the trend, 1M LE>0.5M LE>1M NE>0.5M NE. A lower CE indicated more electrolytes were oxidized in that cycle, considering cathode active sides are not damaged during cycling. The LE possessed better stability towards oxidation, and the stability improved with a higher salt concentration.

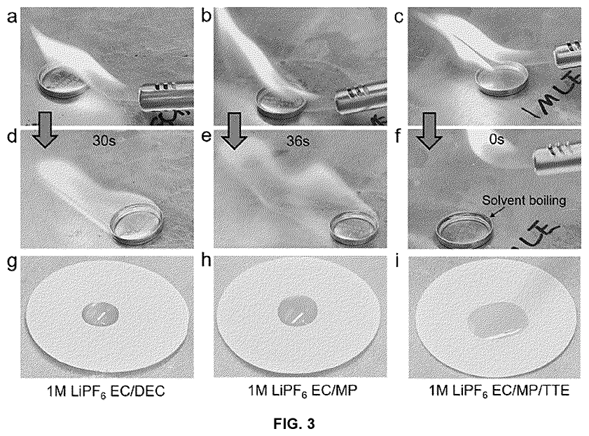

Solvation structures and physical properties. The flammability of the electrolytes was tested by igniting 500 μL electrolytes with a fire torch and recording the burning time (FIGS. 3a-c). 1M LiPF₆ in EC/DEC and 1M LiPF₆ in EC/MP (NE) burned for 30 s and 36 s before self-extinguishing (FIGS. 3d and e). In contrast, 1M LiPF₆ in EC:MP:TTE (LE) did not catch fire after 4 ignition attempts, even though solvent boiling was observed (FIG. 3f). Without wishing to be bound by theory, the low boiling point TTE (50° C.) may have evaporated before other solvents and quenched the fire; for example, with fluorine radicals (F.). 12 The wettability of electrolytes was characterized by dropping 8 μL of electrolyte on the polypropylene (PP) separator and recording the image after 3 seconds. As shown in FIG. 3g-i, neither 1M LiPF₆ in EC/DEC nor 1M LiPF₆ in EC/MP NE electrolytes wet the separator well, whereas the 1M LE spread easily over the surface. Without wishing to be bound by theory, this was considered a result of the low viscosity of TTE; and/or that TTE separated solvation shells and reduced the interaction between other solvent molecules. A similar trend was observed on the electrodes'surface. The increased wettability of LE was reflected on the rate performance with lean electrolytes, which is discussed in the later section.

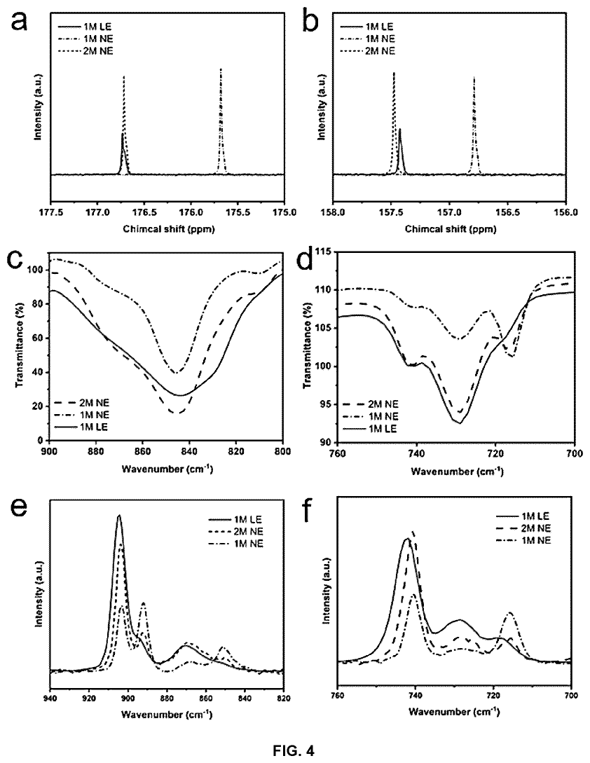

The Li⁺ solvation structure was studied by ¹³C NMR, Fourier Transform infrared spectroscopy (FTIR), and Raman spectroscopy. ¹³C NMR spectra of 1M LE (LiPF₆ in EC:MP:TTE=1:3:4), 1M NE (LiPF₆ in EC:MP=1:3), and 2M NE (LiPF₆ in EC:MP=1:3) are shown in FIGS. 4a and b. The peaks observed within the range of 175 to 177 ppm were attributed to the carbonyl carbon in MP (methyl propionate), and the peaks in the range of 156 to 158 ppm originated from the carbonyl carbon in EC (ethylene carbonate). Without wishing to be bound by theory, it was considered that both peaks shifted downfield for 1M LE and 2M NE due to a higher percent of EC and MP coordinated to Li⁺ and their electron density being pulled away by Li⁺, exhibiting less shielding effect on the carbon nuclei. ¹³C NMR spectra suggested that 1M LE possessed a solvation environment closer to 2M NE. The PF6 signal was classified as free PF₆⁻ (845 cm −1) and Li⁺ coordinated PF₆⁻ (e.g., contact ion pairs, CIPs) at 834 and 870 cm⁻¹.¹³ As shown in FIG. 4c, both 2M NE and 1M LE possessed more CIP feature than 1M NE, which suggested that the average distance between Li⁺ and PF₆⁻ was closer in 2M NE and 1M LE than 1M NE. C═O vibration region is shown in FIG. 4d. The peak height ratio of solvated MP (1714 cm⁻¹)/free MP (1738 cm⁻¹) decreased after increasing salt concentration from 1M NE to 2M NE. Although 1M LE's solvation was expected to be similar to 2M NE, it was observed that the peak of free MP diminishes completely for 1M LE. Likewise, the signal at 1776 cm ⁻¹ was associated with solvated EC 14, and its intensity ratio with the neighbor peak at 1810 cm⁻¹ (assigned to free EC) decreased gradually from 1M NE to 2M NE to 1M LE. Similar solvation structure information was observed from the Raman spectrum (FIGS. 4e and f).

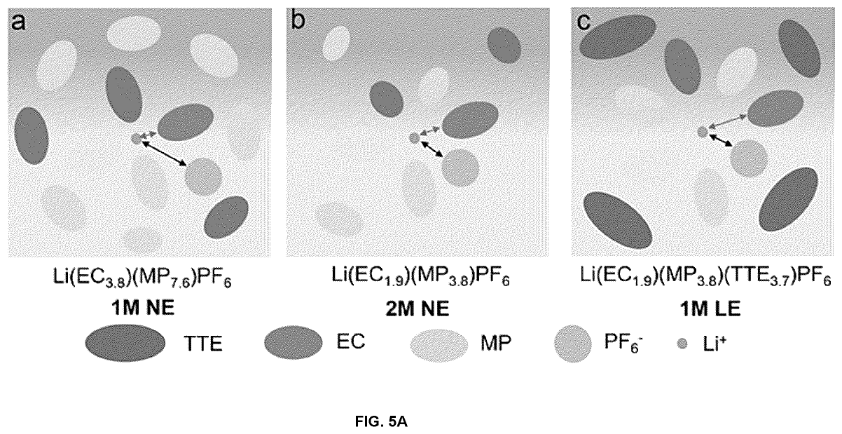

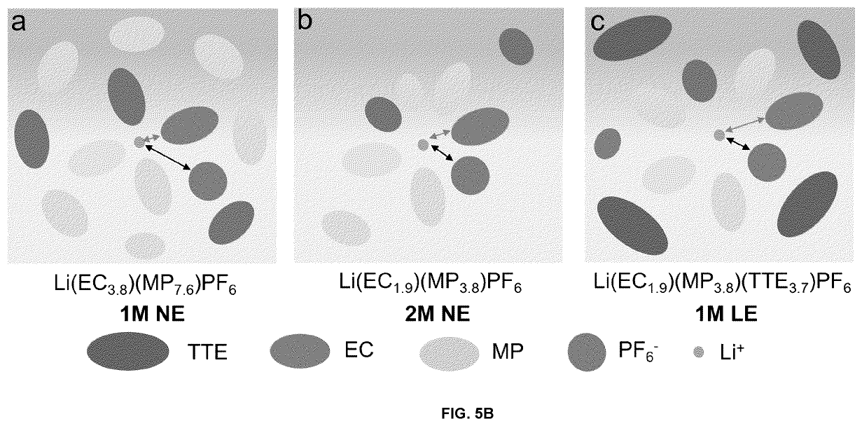

Solvation structure models were proposed based on the abovementioned information (see FIGS. 5Aa-c; FIGS. 5Ba-c). The bulk electrolyte was considered as repeating units of the individual model. The stoichiometric number was calculated by salt concentration and solvents'volume. The solvation number of EC and MP was quantified by the deconvoluted peak area in Raman spectroscopy. In 1M NE, each Li-ion was solvated by 1.8 EC and 2.1 MP (1.8 EC and 2.1 MP present in the first solvation shell). The first solvation shell was surrounded by 2 uncoordinated EC and 5.5 uncoordinated MP. In 2M NE, each Li-ion was solvated by 1.4 EC and 3.3 MP, surrounded by 0.5 free EC and 0.5 free MP. As for 1M LE, Li-ion was coordinated by 1.5 EC and 3.6 MP. The EC and MP participated in the solvation of Li-ion, and each solvation shell was separated by TTE. Although the LE possessed more solvating solvents in the solvation shell, the coordination between Li-ion and each solvent was much weaker. Without wishing to be bound by theory, the distance between EC/MP and Li-ion was considered to be as follows, based on spectroscopy data: 1M NE<2M NE<1M LE, and the distance between PF₆⁻ and Li-ion should follow: 1M LE∞2M NE<1M NE. Without wishing to be bound by theory, this relatively unique solvation structure of 1M LE may bring with it a number of advantages. Firstly, the EC and MP solvents may have increased mobility in the LE due to a decreased intermolecular interaction between them due to separation by TTEs. The solution was found to be highly fluid rather than becoming gel-like, which was reflected in its relatively high wettability (FIG. 3i). Secondly, based on spectroscopy data, it appeared that despite having large solvation numbers, each solvent was more loosely bonded to Li-ion. The weaker coordination between Li-ion and each solvating solvent made Li-ions easier to intercalate/deintercalated into the electrodes. Lastly, the EC and MP were coordinated to Li-ion, which reduced the flammability of the electrolyte.

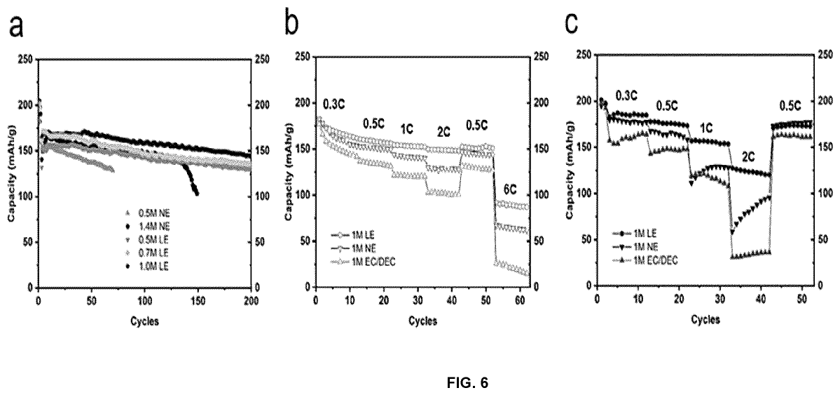

Full cell performance. At the first cycle, the graphite∥NCM622 (LiNi_{0.6}Mn_{0.2}C_{00.2}O₂) cell with 1M LiPF₆ in EC:MP:TTE=1:3:4 (LE) had a charge capacity of 233.3 mAh/g and a discharge capacity of 195.7 mAh/g (Coulombic efficiency (CE)=83.9%). In comparison, 1M LiPF₆ in EC:MP=1:3 (NE) demonstrated a charge capacity of 260 mAh/g and a discharge capacity of 190.9 mAh/g (CE=73.4%). The cycling performance of different electrolytes is shown in FIG. 6a. 1M LE retained 143.9 mAh/g at the 200^{th} cycle, and the 0.7M LE and 0.5M LE retained 135.1 and 131.3 mAh/g, respectively. LE sustained reasonable capacity retention even at a concentration of 0.5M. In contrast, the capacity of 0.5M NE dropped to 128.4 mAh/g at the 70th cycle. Even after increasing the concentration of NE to 1.4M, its capacity declined to 103.3 mAh/g at the 149^{th} cycle. NE demonstrated more capacity decay at different concentrations compared with LE.

The rate capability of the electrolytes was tested with different electrolyte amounts. To fabricate the cells with excess electrolyte, a glass separator was used to soak a large amount of electrolyte. For the cells with excess electrolyte, 1M LE outperformed 1M NE and 1M EC/DEC at different rates, notably at 2C (FIG. 6b). This phenomenon was more obvious for the cells with lean electrolytes (FIG. 6c). Without wishing to be bound by theory, the excellent rate capability of the LE was attributed to its lower viscosity and higher wettability.

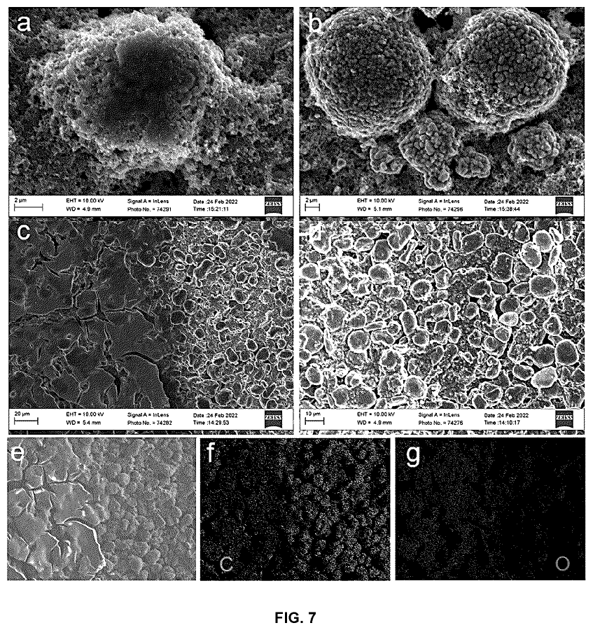

The cycled graphite∥NCM622 cells were opened for post-mortem analysis. FIG. 7(a) shows the NMC622 cathode with 1.4M NE, cycled after 149 cycles. The secondary cathode particle was covered with a thick layer of coating, which was likely the oxidative decomposition product of the electrolyte. In contrast, the surface of NMC622 cathode with 1M LE, cycled after 200 cycles, was still clean, where individual primary particles were still observed (FIG. 7b). The SEM image indicated 1M LE possesses better stability towards oxidation than 1.4M NE, which corroborated with the CE tested in cathode half cells (FIG. 2b). FIG. 7(c) presents a graphite anode with 1.4M NE, cycled 149 cycles. A boundary can be observed in the middle of the image; the right side is the typical morphology of a graphite anode, similar to the cell with 1M LE after 200 cycles (FIG. 7d). The EDX mapping of the two regions is shown in FIGS. 7e-g. The right region was rich in carbon signals coming from the graphite particles. The left area was full of oxygen signals, which may have originated from Li₂O, LiOH, or Li₂CO₃. Those compounds tend to be included in the oxidation layer on Li metal, indicating severe Li plating in the cell with 1.4M NE. Li plating can cause significant capacity decay in a LiB, which may explain the sudden drop of capacity in 1.4M NE after 120 cycles, as shown in FIG. 6b.

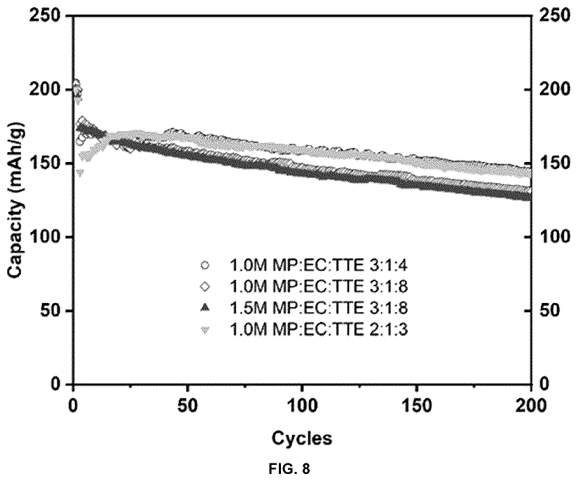

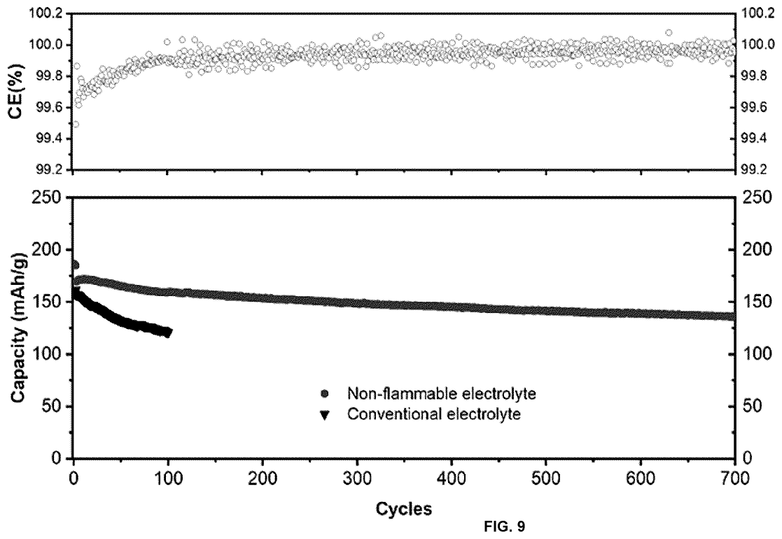

FIG. 8 shows the cycling performance of graphite∥NCM622 employing LEs with different MP:EC:TTE ratios and different LiPF₆ concentrations. All four of the LE compositions demonstrated comparable performance, suggesting that the design of LE can be flexible. A higher TTE percentage may allow the electrolyte to be more flame-retardant; a lower TTE percentage may lead to higher ionic conductivity. A higher salt concentration may improve the anodic stability of the electrolyte. Vinylene carbonate can be used as an electrolyte additive to form a passivation film on both cathode and anode. 2 wt % VC was added into 0.7M LE (MP:EC:TTE=3:1:4) and compared the cell performance with 0.7M NE+2 wt % VC (FIG. 9). The cell with 0.7M LE+2 wt % VC delivered a capacity of 141.5 mAh/g at the 500^{th} cycle, which is 83.5% of the initial capacity; and the averaged CE was 99.95% from the 100^{th} to 700^{th} cycle. In comparison, the cell with 0.7M NE+2 wt % VC dropped to 121.1 mAh/g after 100 cycles.

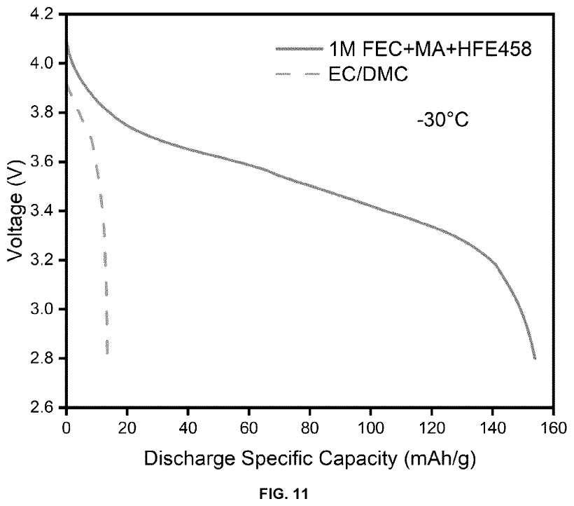

FIG. 11 shows a discharge voltage profile of a graphite∥NCA (LiNi_{0.8}CO_{0.15}Al_{0.5}O₂) cell employing 1M LiPF₆ in MA:FEC:HFE 458=5:1:6(1M LE), where MA is methyl acetate, FEC is fluoroethylene carbonate, and HFE-458 is 1,1,2,2-tetrafluoroethyl-2,2,3,3-tetrafluoropropyl ether, in comparison to a graphite∥NCA cell with 1M LiPF₆ in EC:DMC=1:1. As depicted, it was demonstrated that a galvanic cell, otherwise referred to as a battery, comprising an electrolyte as described herein (e.g., 1M LiPF₆ in MA:FEC:HFE 458=5:1:6) delivered a higher discharge capacity at −30° C. than a battery containing 1M LiPF₆ in EC:DMC=1:1 as electrolyte (FIG. 11).

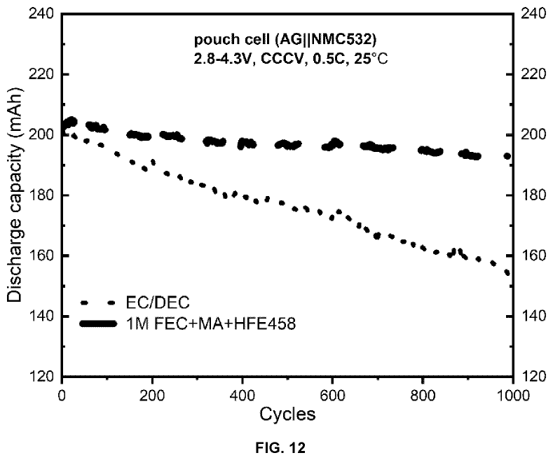

FIG. 12 shows the capacity retention of a pouch cell using a graphite anode and LiNi_{0.5}Mn_{0.3}C_{00.2}O₂ (NMC₅₃₂) cathode with 1M LiPF₆ in MA:FEC:HFE-458=5:1:6 as electrolye, in comparison to the pouch cell with 1M LiPF₆ in EC:DMC=1:1 as electrolyte. As depicted, It was demonstrated that the pouch cell using a graphite anode and a LiNi_{0.5}Mn_{0.3}C_{00.2}O₂ (NMC₅₃₂) cathode with an electrolyte as described herein (e.g., 1M LiPF₆ in MA:FEC:HFE 458=5:1:6) had better capacity retention than the pouch cell with 1M LiPF₆ in EC:DMC=1:1.

### REFERENCES

1. J.-M. T. Armand, M., Nature, 414, 359-367 (2001) http://www.ncbi.nlm.nih.gov/pubmed/11713543.
2. J. E. Harlow, X. Ma, J. Li, E. Logan, Y. Liu, N. Zhang, L. Ma, S. L. Glazier, M. M. E. Cormier, M. Genovese, S. Buteau, A. Cameron, J. E. Stark, and J. R. Dahn, J. Electrochem. Soc., 166, A3031-A3044 (2019).
3. J. B. Goodenough and K. S. Park, J. Am. Chem. Soc., 135, 1167-1176 (2013).
4. S. Chen, J. Zheng, D. Mei, K. S. Han, M. H. Engelhard, W. Zhao, W. Xu, J. Liu, and J. G. Zhang, Adv. Mater., 30, 1706102 (2018).
5. X. Cao, H. Jia, W. Xu, and J.-G. Zhang, J. Electrochem. Soc., 168, 010522 (2021).

6. X. Zhang, L. Zou, Y. Xu, X. Cao, M. H. Engelhard, B. E. Matthews, L.
ong, H. Wu, H. Jia, X. Ren, P. Gao, Z. Chen, Y. Qin, C. Kompella, B. W. Arey, J. Li, D. Wang, C. Wang, J. G. Zhang et al., Adv. Energy Mater., 10, 2000368 (2020).
7. X. Ma, P. Zhang, H. Zhao, Q. Wang, G. Zhang, S.-S. Chi, Z. Liu, Y. Qian, J. Wang, C. Wang, and Y. Deng, Liquids, 1, 60-74 (2021).
8. X. Fan, X. Ji, L. Chen, J. Chen, T. Deng, F. Han, J. Yue, N. Piao, R. Wang, X. Zhou, X. Xiao, L. Chen, and C. Wang, Nat. Energy, 4, 882-890 (2019) http://dx.doi.org/10.1038/s41560-019-0474-3.
9. E. R. Logan, D. S. Hall, M. M. E. Cormier, T. Taskovic, M. Bauer, I. Hamam, H. Hebecker, L. Molino, and J. R. Dahn, J. Phys. Chem. C, 124, 12269-12280 (2020).
10. R. Petibon, J. Harlow, D. B. Le, and J. R. Dahn, Electrochim. Acta, 154, 227-234 (2015).
11. Y. G. Cho, M. Li, J. Holoubek, W. Li, Y. Yin, Y. S. Meng, and Z. Chen, ACS Energy Lett., 6, 2016-2023 (2021).
12. K. An, Y. H. T. Tran, S. Kwak, J. Han, and S. W. Song, Adv. Funct. Mater., 31, 1-9 (2021).
13. Y. Zou, Z. Cao, J. Zhang, W. Wahyudi, Y. Wu, G. Liu, Q. Li, H. Cheng, D. Zhang, G. T. Park, L. Cavallo, T. D. Anthopoulos, L. Wang, Y. K. Sun, and J. Ming, Adv. Mater., 33(2021).
14. C. Zhou, L. Zheng, T. He, M. A. Garakani, S. Abouali, Y. Shen, L. Chen, and V. Thangadurai, Energy Storage Mater., 42, 295-306 (2021) https://doi.org/10.1016/j.ensm.2021.07.043.

The embodiments described herein are intended to be examples only. Alterations, modifications, and/or variations can be effected to the particular embodiments by those of skill in the art. The scope of the claims should not be limited by the particular embodiments set forth herein, but should be construed in a manner consistent with the specification as a whole.

The aspects, embodiments, and/or examples of the present disclosure being thus described, it should be recognized that said aspects, embodiments, and/or examples may be varied in ways that do not depart from the spirit and scope of the present disclosure, and that said variations are intended to be included within the scope of the following claims.

All publications, patents and patent applications mentioned in this specification are herein incorporated by reference to the same extent as if each individual publication patent, or patent application was specifically and individually indicated to be incorporated by reference.

What is claimed is:

1. An electrochemical cell electrolyte comprising:
a solvating solvent comprising a linear ester, a cyclic ester, or a combination thereof;
a non-solvating solvent; and
an alkali metal salt.

2. The electrolyte of claim 1, wherein the alkali metal salt is present at a concentration between about 1M to about 4M, or between about 1M to about 3M; or between about 1M to about 2M in the solvating solvent.

3. The electrolyte of claim 1 or 2, wherein the alkali metal salt is present at a concentration between about 0.2M to about 3.3M, or between about 0.5M to about 2M; or between about 0.5M to about 1M in the combination of solvating solvent and non-solvating solvent.

4. The electrolyte of any preceding claim, wherein the solvating solvent comprises a linear alkyl ester, a cyclic alkyl ester, or a combination thereof.

5. The electrolyte of any preceding claim, wherein the solvating solvent further comprises a linear carbonate ester, a cyclic carbonate ester, or a combination thereof.

6. The electrolyte of any preceding claim, wherein the solvating solvent comprises an alkyl ethanoate, a fluoro-alkyl ethanoate, an alkyl propionate, a fluoro-alkyl propionate, or a combination thereof.

7. The electrolyte of any preceding claim, wherein the solvating solvent comprises a dialkyl carbonate, a fluoro-dialkyl carbonate, an alkylene carbonate, a fluoro-alkylene carbonate, or a combination thereof.

8. The electrolyte of any preceding claim, wherein the solvating solvent comprises methyl acetate, ethyl acetate, methyl propionate, ethyl propionate, or a combination thereof.

9. The electrolyte of any preceding claim, wherein the solvating solvent comprises ethylene carbonate, fluoroethylene carbonate, vinylene carbonate, or a combination thereof.

10. The electrolyte of any preceding claim, wherein the solvating solvent comprises dimethyl carbonate, diethyl carbonate, propylene carbonate, or a combination thereof.

11. The electrolyte of any preceding claim, wherein the non-solvating solvent comprises a linear fluoro-alkyl ether.

12. The electrolyte of any preceding claim, wherein the non-solvating solvent comprises benzotrifluoride, methoxyperfluorobutane, bis(2,2,2-trifluoroethyl)ether, 2,2,2-trifluoroethyl acetate, 1H, 1H,5H-octafluoropentyl 1,1,2,2-tetrafluoroethyl ether, 1,1,1,3,3,3-hexafluoroisopropyl methyl ether, 1,1,2,2-tetrafluoroethyl-2,2,2-trifluoroethyl ether, 1,1,2,2-tetrafluoroethyl-2,2,3,3-tetrafluoropropyl ether, or a combination thereof.

13. The electrolyte of any preceding claim, wherein the solvating solvent makes up about 20% to about 80% of the total volume.

14. The electrolyte of any preceding claim, wherein the linear ester, cyclic ester, or combination thereof make up about 20% to about 99% of the solvating solvent, and/or the linear carbonate ester, cyclic carbonate ester, or combination thereof make up about 1% to about 80% of the solvating solvent.

15. The electrolyte of any preceding claim, wherein the non-solvating solvent makes up about 10% to about 80% of the total volume.

16. The electrolyte of any preceding claim, wherein the alkali metal salt comprises a lithium salt, sodium salt, potassium salt, rubidium salt, or cesium salt.

17. The electrolyte of any preceding claim, wherein the alkali metal salt comprises a lithium salt, sodium salt, or potassium salt.

18. The electrolyte of any preceding claim, wherein the alkali metal salt comprises a lithium salt, or sodium salt.

19. The electrolyte of any preceding claim, wherein the alkali metal salt comprises a lithium salt.

20. The electrolyte of any preceding claim, wherein the alkali metal salt comprises a lithium cation and a fluoro-substituted anion.

21. The electrolyte of any preceding claim, wherein the alkali metal salt comprises lithium hexafluorophosphate (LiPF₆), lithium bis(fluorosulfonyl)imide (LiFSI), lithium difluorophosphate (LFO), lithium bis(oxalato)borate (LiBOB), lithium difluoro(oxalato)borate (LiDFOB), lithium bis(trifluoromethylsulphonyl)imide (LITFSI), lithium tetrafluoroborate(LiBF₄), or a combination thereof.

22. The electrolyte of any preceding claim, further comprising an electrolyte additive.

23. The electrolyte of any preceding claim, wherein the electrolyte additive comprises an alkylene carbonate; carbon dioxide, ethylene sulfite, ethylene sulfate, propylene sulfite, 1,3-propane sultone, 1,3-propene sultone, perfluoro(2-methyl-3-pentanone); or a combination thereof.

24. A battery comprising the electrolyte of any one of claims 1 to 23.

25. A half galvanic cell comprising a reference electrode, a working electrode, and the electrolyte of any one of claims 1 to 23.

26. A full galvanic cell comprising an anode, a cathode, and the electrolyte of any one of claims 1 to 23.

27. The galvanic cell of any one of the preceding claims, where the reference electrode comprises Li; the working electrode comprises graphite, silicon, a graphite/silicon mixture, LiNi_{0.6}Mn_{0.2}C_{00.2}O₂ (NMC₆₂₂), LiNi_{0.5}Mn_{0.3}C_{00.2}O₂ (NMC₅₃₂), LiCOO₂, LiFePO₄, NCA, NMC811, an Li metal oxide, an Li metal oxide comprising Ni, Mn, Co, and/or Al, or a combination thereof; the anode comprises graphite, silicon, a graphite/silicon mixture, or a combination thereof; the cathode comprises LiNi_{0.6}Mn_{0.2}Co_{0.2}O₂ (NMC₆₂₂), LiNi_{0.5}Mn_{0.3}C_{00.2}O₂ (NMC532), LiCoO₂, LiFePO₄, NCA, NMC811, an Li metal oxide, an Li metal oxide comprising Ni, Mn, Co, and/or Al, or a combination thereof; or a combination thereof.

28. An electrochemical cell comprising:
an anode;
a cathode; and
an electrolyte, the electrolyte comprising:
a solvating solvent comprising a linear ester, a cyclic ester, or a combination thereof;
a non-solvating solvent; and
an alkali metal salt.

29. The cell of claim 28, wherein the alkali metal salt is present at a concentration between about 1M to about 4M, or between about 1M to about 3M; or between about 1M to about 2M in the solvating solvent.

30. The cell of any preceding claim, wherein the alkali metal salt is present at a concentration between about 0.2M to about 3.3M, or between about 0.5M to about 2M; or between about 0.5M to about 1M in the combination of solvating solvent and non-solvating solvent.

31. The cell of any preceding claim, wherein the solvating solvent comprises a linear alkyl ester, a cyclic alkyl ester, or a combination thereof.

32. The cell of any preceding claim, wherein the solvating solvent further comprises a linear carbonate ester, a cyclic carbonate ester, or a combination thereof.

33. The cell of any preceding claim, wherein the solvating solvent comprises an alkyl ethanoate, a fluoro-alkyl ethanoate, an alkyl propionate, a fluoro-alkyl propionate, or a combination thereof.

34. The cell of any preceding claim, wherein the solvating solvent comprises a dialkyl carbonate, a fluoro-dialkyl carbonate, an alkylene carbonate, a fluoro-alkylene carbonate, or a combination thereof.

35. The cell of any preceding claim, wherein the solvating solvent comprises methyl acetate, ethyl acetate, methyl propionate, ethyl propionate, or a combination thereof.

36. The cell of any preceding claim, wherein the solvating solvent comprises ethylene carbonate, fluoroethylene carbonate, vinylene carbonate, or a combination thereof.

37. The cell of any preceding claim, wherein the solvating solvent comprises dimethyl carbonate, diethyl carbonate, propylene carbonate, or a combination thereof.

38. The cell of any preceding claim, wherein the non-solvating solvent comprises a linear fluoro-alkyl ether.

39. The cell of any preceding claim, wherein the non-solvating solvent comprises benzotrifluoride, methoxyperfluorobutane, bis(2,2,2-trifluoroethyl)ether, 2,2,2-trifluoroethyl acetate, 1H, 1H,5H-octafluoropentyl 1,1,2,2-tetrafluoroethyl ether, 1,1,1,3,3,3-hexafluoroisopropyl methyl ether, 1,1,2,2-tetrafluoroethyl-2,2,2-trifluoroethyl ether, 1,1,2,2-tetrafluoroethyl-2,2,3,3-tetrafluoropropyl ether, or a combination thereof.

40. The cell of any preceding claim, wherein the solvating solvent makes up about 20% to about 80% of the total volume.

41. The cell of any preceding claim, wherein the linear ester, cyclic ester, or combination thereof make up about 20% to about 99% of the solvating solvent, and/or the linear carbonate ester, cyclic carbonate ester, or combination thereof make up about 1% to about 80% of the solvating solvent.

42. The cell of any preceding claim, wherein the non-solvating solvent makes up about 10% to about 80% of the total volume.

43. The cell of any preceding claim, wherein the alkali metal salt comprises a lithium salt, sodium salt, potassium salt, rubidium salt, or cesium salt.

44. The cell of any preceding claim, wherein the alkali metal salt comprises a lithium salt, sodium salt, or potassium salt.

45. The cell of any preceding claim, wherein the alkali metal salt comprises a lithium salt, or sodium salt.

46. The cell of any preceding claim, wherein the alkali metal salt comprises a lithium salt.

47. The cell of any preceding claim, wherein the alkali metal salt comprises a lithium cation and a fluoro-substituted anion.

48. The cell of any preceding claim, wherein the alkali metal salt comprises lithium hexafluorophosphate (LiPF₆), lithium bis(fluorosulfonyl)imide (LiFSI), lithium difluorophosphate (LFO), lithium bis(oxalato)borate (LiBOB), lithium difluoro(oxalato)borate (LIDFOB), lithium bis(trifluoromethylsulphonyl)imide (LITFSI), lithium tetrafluoroborate(LiBF₄), or a combination thereof.

49. The cell of any preceding claim, wherein the electrolyte further comprises an electrolyte additive.

50. The cell of any preceding claim, wherein the electrolyte additive comprises an alkylene carbonate; carbon dioxide, ethylene sulfite, ethylene sulfate, propylene sulfite, 1,3-propane sultone, 1,3-propene sultone, perfluoro(2-methyl-3-pentanone); or a combination thereof.

51. The cell of any preceding claim, wherein the anode comprises graphite, silicon, a graphite/silicon mixture, or a combination thereof; the cathode comprises LiNi_{0.6}Mn_{0.2}C_{00.2}O₂ (NMC₆₂₂), LiNi_{0.5}Mn_{0.3}C_{00.2}O₂ (NMC₅₃₂), LiCoO₂, LiFePO₄, NCA, NMC811, an Li metal oxide, an Li metal oxide comprising Ni, Mn, Co, and/or Al, or a combination thereof; or a combination thereof.

52. The cell of any preceding claim, wherein the cell is a galvanic cell.

53. The cell of any preceding claim, wherein the cell is a battery.

54. The cell of any preceding claim, wherein the cell is useful for smart windows.

55. The cell of any preceding claim, wherein the cell is useful for sensors.

56. The battery of claim 24, wherein the battery is operable at a temperature of about −30° C. or higher.

57. The cell of any one of claims 25 to 55, wherein the cell is operable at a temperature of about −30° C. or higher.
